(19) United States
(12) Patent Application Publication
(10) Pub. No.: US 2009/0327125 A1
(43) Pub. Date: Dec. 31, 2009

(54) ENHANCED MEDIA SUBSCRIPTION

(75) Inventor: Kamal Jain, Bellevue, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/146,459

(22) Filed: Jun. 26, 2008

(51) Int. Cl. G06Q 30/00; H04L 9/32; G06Q 10/00

(52) U.S. Cl. 705/40; 726/28; 705/1; 705/400

(57) ABSTRACT

The described implementations relate to enhanced media subscription services. One technique provides digital rights restricted media to a consumer for a period. At the end of the period, based at least in part on consumer use, the technique removes the digital rights restrictions from some of the media and deletes other of the media.

### BACKGROUND

A consumer who considers obtaining media, such as music can select from several supply models. First, the consumer can select and purchase individual songs. For instance, the user can go to an on-line music store and purchase a number of songs. Consumers tend to dislike this option due to price considerations when large numbers of songs are purchased. Second, the consumer can sign up for a subscription service where the consumer pays a fee to listen to songs during a subscription period. Consumers tend to dislike subscription services in that the consumer's access to the songs ends with the conclusion of the subscription period (i.e., the consumer is left feeling empty-handed). Third, the consumer can listen to broadcast or internet radio. Consumers tend not to like the radio scenario in that the supplier selects the songs and the consumer is again left empty-handed after listening to the songs. The present concepts address these and other scenarios.

### SUMMARY

The described implementations relate to enhanced media subscription services. One technique provides digital rights restricted media to a consumer for a period. At the end of the period, based at least in part on consumer use, the technique removes the digital rights restrictions from some of the media and deletes other of the media.

Another implementation is manifested as a system that offers enhanced media subscriptions to consumers. The system includes a media selection module configured to make a set of digital rights restricted songs available to a consumer for a given time period and an activity module configured to track the consumer's use of individual songs of the group of songs during the given time period. The system also includes a digital rights management module configured to remove the digital rights restriction from a sub-set of relatively high use songs at the end of the given time period. The above listed examples are intended to provide a quick reference to aid the reader and are not intended to define the scope of the concepts described herein.

### BRIEF DESCRIPTION OF THE DRAWINGS

The accompanying drawings illustrate implementations of the concepts conveyed in the present application. Features of the illustrated implementations can be more readily understood by reference to the following description taken in conjunction with the accompanying drawings. Like reference numbers in the various drawings are used wherever feasible to indicate like elements. Further, the left-most numeral of each reference number conveys the Figure and associated discussion where the reference number is first introduced.

FIG. 1 illustrates an exemplary enhanced media subscription system or technique in accordance with some implementations of the present concepts.

FIG. 2 shows various scenarios that can illustrate enhanced media subscription concepts in accordance with some implementations of the present concepts.

FIG. 3 illustrates an exemplary enhanced media subscription system in accordance with some implementations of the present concepts.

FIG. 4 is a flowchart of an exemplary enhanced media subscription technique in accordance with some implementations of the present concepts.

### DETAILED DESCRIPTION

### Overview

This patent application pertains to enhanced media subscription services. Some of the present implementations allow a set of media to be supplied to a user or consumer for a period of time (i.e., subscription period). The consumer can use all of the supplied media during the subscription period and can be allowed to keep a sub-set of his/her favorites at the end of the subscription period.

Viewed one way, the consumer pays for access to a relatively large amount of media during the subscription period and as a result gets to keep his/her favorite media. Viewed still another way, the consumer agrees to buy a specific number of media from a set selected by the supplier and for doing so the consumer gets use of the whole set of media for a period of time.

### Exemplary Implementations

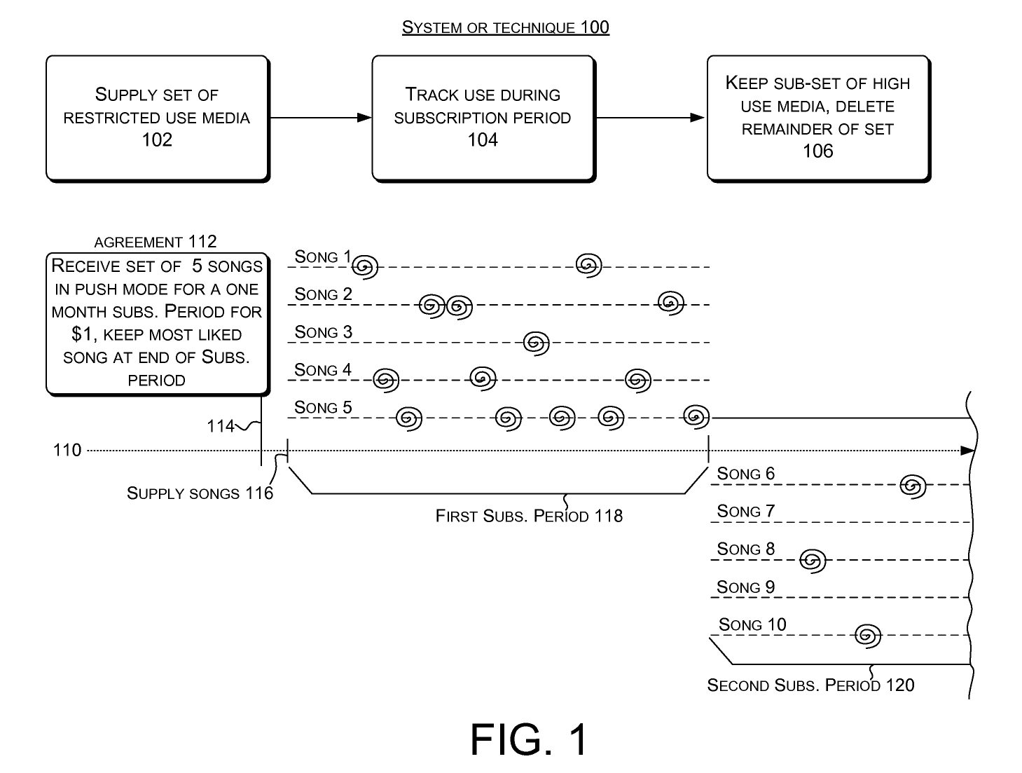

For discussion purposes consider FIG. 1 which shows one enhanced media subscription system or technique 100. In this case, technique 100 includes three blocks 102, 104, and 106. Briefly, block 102 supplies a set of restricted use media. Block 104 tracks use of the set of media during a time period. Block 106 keeps a sub-set of high use media and deletes a remainder of the set. For purposes of explanation, technique 100 is described in conjunction with a timeline 110 that offers an example of technique 100 where the media is in the form of songs. Timeline 110 progresses chronologically from left to right in FIG. 1.

Timeline 110 begins with an agreement 112 being established between a media supplier and a consumer at point 114 on the timeline. Agreement 112 defines that the consumer will receive a set of five songs for a one month subscription period for $1 and that the consumer can keep the most liked song at the end of the subscription period. Although not expressly shown on agreement 112, assume for discussion purposes that the agreement includes twelve sequential one month subscription periods. Of course, this is just an example and subscription periods can be any duration, from less than a day to more than a year. Further, some agreements may relate to only a single subscription period or any number of subscription periods besides the number twelve included here. Further, any number of songs can be included in the set of songs and in many cases a set of songs can include hundreds of songs. The consumer can be allowed to keep any sub-set of the songs. In this case a set of five songs and a sub-set of one of those five songs are used for sake of brevity. In another example, the set of songs may include 300 songs and the consumer gets to keep a sub-set of 15 songs at the end of the subscription period for a total price of fifteen dollars.

As introduced above in the general setting of technique 100, restricted-use media can be supplied to the user or consumer at block 102. In relation to the example of timeline 110 restricted-use songs are supplied at point 116 on the timeline. The consumer can download the supplied restricted use media to a media player. Assume for sake of brevity that in this case, restricted-use songs means that the songs can only be played on the media player upon which they were downloaded.

In this case, the set of songs supplied at point 116 are indicated as individual horizontal dashed lines labeled “song 1”, “song 2”, “song 3”, “song 4” and “song 5” relative to the timeline starting at the chronological point 116 that they are first made available to the consumer and extending to the right on the timeline for a duration of time that the songs are available (i.e., first subscription period 118). During first subscription period, 118 songs 1-5 are indicated as dashed lines to indicate the restricted use nature of the songs.

As introduced above, technique 100 can track or monitor the consumer's usage of the restricted-use media at block 104. For instance, in the example of timeline 110 consumer usages can be tracked in terms of spins during first subscription period 118. Spins are graphically represented relative to timeline 110 with a spin [symbol] symbol. A spin is where the consumer plays at least a given substantial amount of an individual song, such as 30 seconds. So for instance, if the consumer is scanning through their songs and plays a couple seconds of each song while looking for a particular song, then that is not considered a spin. If on the other hand the consumer plays say a minute of the song, then that is considered a spin.

In first subscription period 118, the tracked usage indicates that song 1 was spun two times (i.e., two spin [symbol] symbols on the song 1 horizontal line). Similarly, song 2 was spun three times, song 3 was spun one time, song 4 was spun three times and song 5 was spun five times. The tracked usage can be utilized to automatically determine which song(s) the consumer liked the most. This is not a subjective determination, but is instead based upon the consumer's actions during the subscription period. For example, in this case, the consumer spun song 5 more times than any other song (five times compared to three times for the next highest spun song). Accordingly, the consumer's actions show that he/she liked song 5 more than the other songs.

As mentioned above, technique 100 can keep a sub-set of high use media and delete the remainder of the set. In relation to the example of timeline 110, the agreement 112 allows the consumer to keep one song. So in this implementation, the sub-set is one song and in this instance the highest use song is song 5 as discussed above. Accordingly, at the end of first subscription period 118, the consumer gets to keep song 5. Further, at this point the use-restriction of song 5 is removed. In relation to timeline 110 the removal of the use-restriction of song 5 is indicated by a transition from a dashed line to a solid line at the end of first subscription period 118. The solid line of song 5 extends for the remainder of timeline 110. At this point, the consumer can be thought of as owning song 5 free and clear. So for instance, the consumer can now copy song 5 to another media player.

In contrast, at the end of first subscription period 118, songs 1-4 (i.e., the remainder of the set of songs) are deleted or otherwise made unavailable or inaccessible to the consumer. In relation to timeline 110, the horizontal dashed lines associated with songs 1-4 terminate at the end of the first subscription period to indicate that these songs are now unavailable to the consumer.

In the example of timeline 110, the end of first subscription period 118 coincides with a beginning of second subscription period 120. Second subscription period 120 supplies a new set of restricted use songs 6-10 to the consumer. The consumer's use of songs 6-10 can be tracked during second subscription period 120 in a similar manner to the tracking described above in relation to first subscription period 118.

During second subscription period 120, the consumer has access to restricted-use songs 6-10 and access to unrestricted song 5. At the conclusion of second subscription period 120 (not shown), the consumer can be given unrestricted use of one of songs 6-10 with the remainder deleted. So, during a subsequent third subscription period the consumer can have unrestricted access to song 5 plus another song from the second subscription period 120 and restricted-use access to an additional five songs supplied in the third subscription period. In some implementations, at the end of the agreed upon number of subscription periods, the user still has the sub-set of songs from each subscription period that the consumer now owns free and clear. For instance, since the present example includes twelve subscription periods, at the end of the twelfth subscription period, the consumer still has his/her twelve favorite songs including one song from each subscription period.

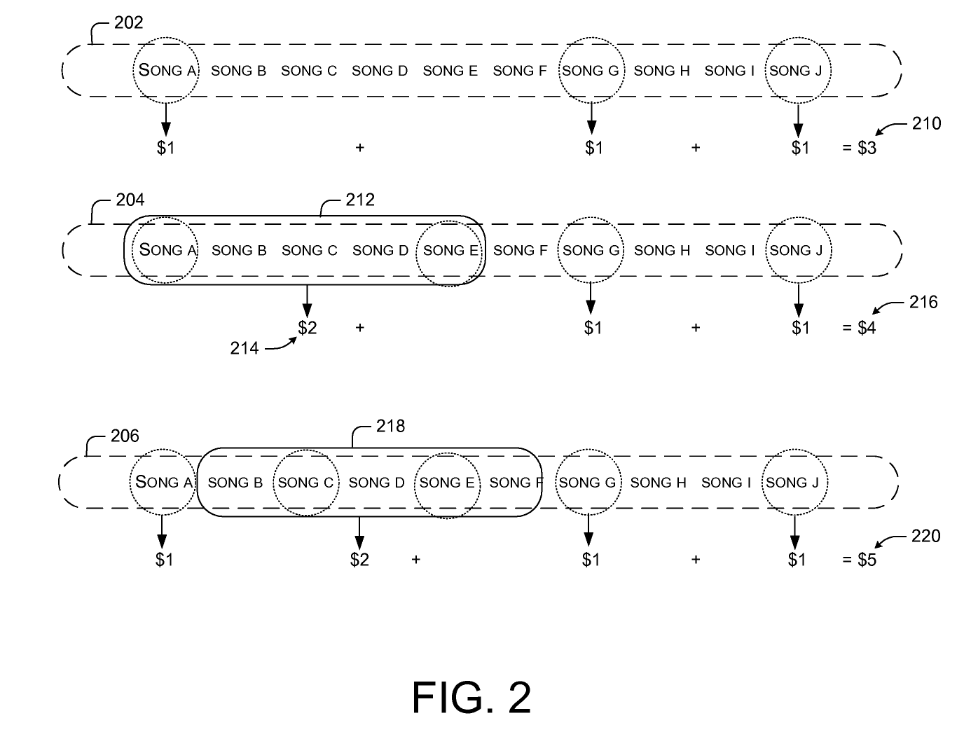

FIG. 2 shows a hypothetical example of how the present enhanced media subscriptions can be beneficial from both a media supplier perspective and a media consumer perspective. Assume for sake of brevity that there only 10 songs available in the world (songs A-J). Songs A-J are indicated generally in a first scenario at 202, a second scenario 204, and a third scenario 206. Assume further that the consumer has decided that there are only three songs; song A, song G, and song J that the consumer likes well enough to justify the purchase price. For ease of explanation, assume that the purchase price is one dollar per song, so under the first scenario 202, the total potential revenue from the consumer is three dollars as indicated at 210 ($1+$1+$1=$3).

Now consider second scenario 204 and assume that the consumer signs up for an enhanced media subscription and that the terms of the subscription are: for one subscription period that involves five songs indicated generally at 212. The cost of the subscription is two dollars as indicated at 214. Further, in this case, assume that the supplied songs are songs A-E and that the two highest use songs that are given to the consumer at the end of the subscription period are song A and song E. In this scenario, the total potential revenue from the consumer is now four dollars ($2+$1+$1=$4) as indicated at 216 rather than $3 indicated at 210 in the first scenario. The total potential revenue is now $4 in that the consumer paid two dollars in a subscription fee and as a result now owns songs A and E and is still likely to buy songs G and J.

The consumer is satisfied in that the enhanced subscription service offers the consumer a chance to listen to music with which he/she otherwise might not have been familiar. In this case, not only did the consumer get to listen to lots of music during the subscription period, but they got to buy song A which they had already decided to buy and they also got to buy song E that they maybe didn't even know about prior to the subscription service.

In third scenario 206, assume that the consumer purchased songs A, G, and J from the supplier and signed up for the enhanced subscription service. In this case, the supplier can supply a set of five songs 218 that purposefully does not include songs A, G, and J to the consumer for the subscription period. Accordingly, the potential revenue from the consumer rises to five dollars as indicated at 220 ($1 for the sale of song A+$2 for the subscription price+$1 for the sale of song G+$1 for the sale of song J=$5). In second and third scenarios 204 and 206, the supplier can potentially make more revenue than in first scenario 202. Further, the consumer gets increased value in that the cost to purchase songs remains at $1 as consistent with the first scenario 202, but the consumer also gets access to lots of other music during the subscription period for no additional charge. The skilled artisan should recognize other variations that are consistent with the present concepts.

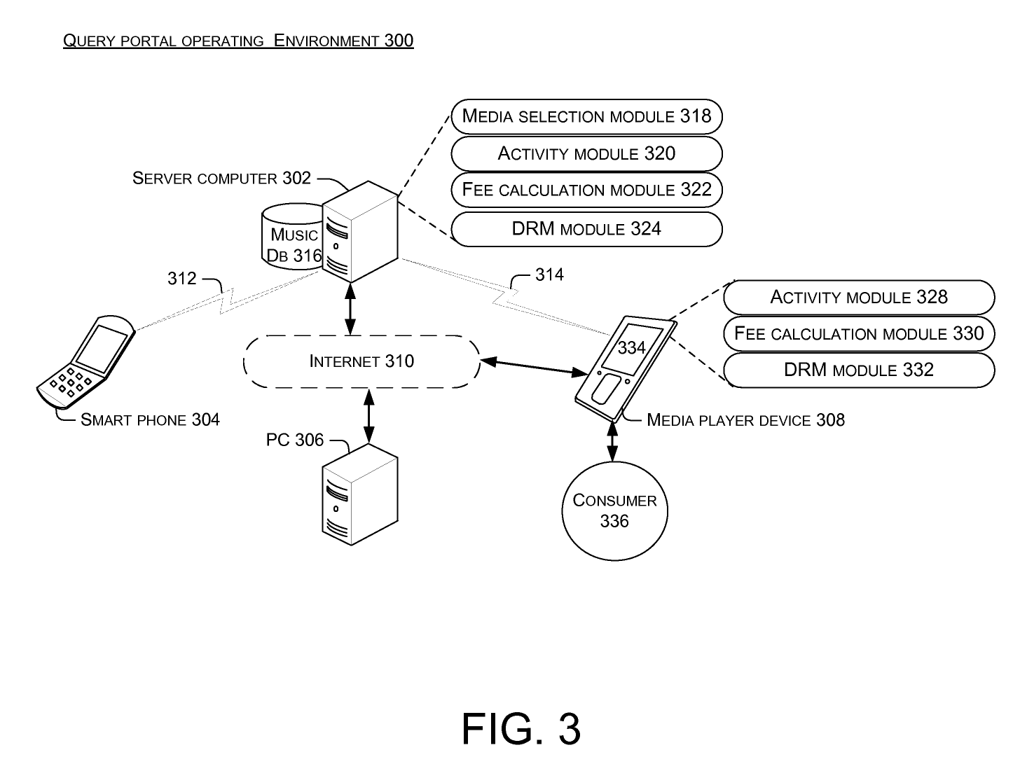

FIG. 3 shows an exemplary operating environment 300 in which enhanced media subscription concepts described above and below can be implemented on various computing devices. This example is directed to media in the form of music, but can be applicable to other forms of media such as video. In this case, the computing devices are manifest as a server computer 302, a smart phone 304, a personal computer 306, and a media player device 308. The computing devices 302-308 can be communicably coupled with one another via the Internet 310 and/or via another communication means such as cellular microwave means 312, 314.

In this configuration, server computer 302 can provide an enhanced music subscription service to one or more of computing devices 304-308. Server computer 302 can include a music database (Db) 316, a music selection module 318, an activity module 320, a fee calculation module 322 and a DRM module 324. For the sake of brevity, the enhanced media subscription service is explained in relation to media player device 308, but can be applied to either or both smart phone 304 and PC 306, and/or other computing devices.

Media player device 308 has several modules that can work in cooperation with server computer 302 to provide the enhanced media subscription service. In this case, media player device 308 includes an activity module 328, a fee calculation module 330, and a DRM module 332.

The server computer's activity module 320 and/or the media player device's activity module 328 can track usage of songs on media player device 308 supplied as part of the enhanced music subscription service offered by server computer 302. The conditions, such as those included in agreement 112 (FIG. 1) can be displayed on a GUI 334 and agreed to by consumer 336 before a set of songs is downloaded from server computer 302 to media player device 308 as part of the enhanced music subscription service. The downloaded songs can include use restrictions imposed by digital rights management module 324. For instance, one condition may be that the songs cannot be copied and that the songs can only be played on media player device 308. DRM module 332 can contain a private key or serial number that DRM module 324 associates with the song to restrict its use.

Once the song is resident on the media player device 308, the consumer can play (i.e., spin) the song. Spins can be tracked on media player device's activity module 328 and/or on the server computing device's activity module 320. Fee calculation modules 322 and/or 330 can calculate fees or payments due based upon terms of the agreement 112. The server computing device's activity module 320 can perform technique 100 (FIG. 1) to determine which songs of the set of songs supplied in a subscription period to keep and which to delete based upon the consumers usage during the subscription period. Once the determination is made by the activity module 320 (and/or 328), the DRM module 324 and/or DRM module 332 can remove the DRM restrictions from the songs that or the consumer is entitled to keep and delete (or otherwise make unavailable) the remainder of the songs of the set.

The efficacy of enhanced music subscription systems can be dependent upon the configuration of individual computing devices. For instance, if the computing device has a restricted configuration so that it can only obtain and play music from specific sources, then the conditions of the agreement tend to be more easily enforced than upon a computing device that can receive music from different sources in different formats. For example, if the media player device is an Apple iPod brand media player device that can only download songs from Apple's itunes store, then DRM restrictions are more easily enforced. Similarly, a Microsoft Corp. Zune® brand media player may be restricted to downloading from the Zune Marketplace™. In contrast, a PC may be able to obtain music from various sources beyond server computer 302 thereby making DRM restrictions more difficult to enforce.

### Exemplary Methods

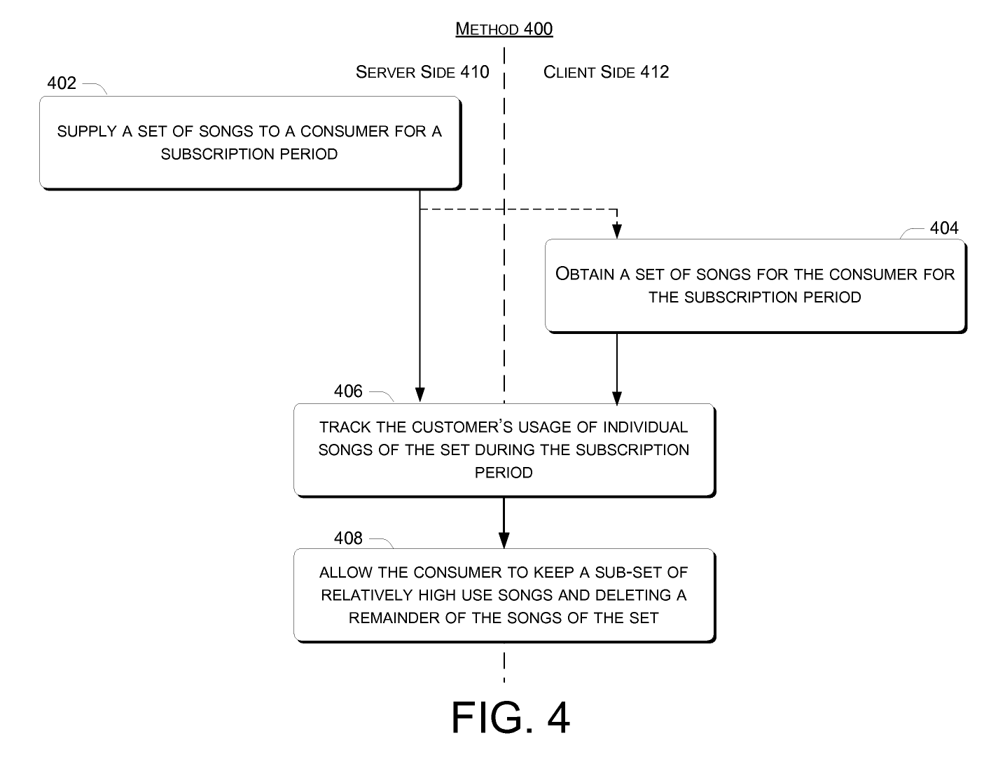

FIG. 4 illustrates a flowchart of a method or technique 400 that is consistent with at least some implementations of the present concepts. The order in which the technique 400 is described is not intended to be construed as a limitation, and any number of the described blocks can be combined in any order to implement the technique, or an alternate technique. Furthermore, the technique can be implemented in any suitable hardware, software, firmware, or combination thereof such that a computing device can implement the technique. In one case, the technique is stored on a computer-readable storage media as a set of instructions such that execution by a computing device causes the computing device to perform the technique.

In this case, technique 400 contains four process blocks 402-408. For discussion purposes, these four process blocks are described in relation to server or supplier side processes 410 and/or client or customer side processes 412.

Block 402 can be a server side process 410 that supplies a set of songs to a consumer for a subscription period. Various examples are described above. The set of songs can be obtained from a database of available songs such as music database 316 (FIG. 3). The set of songs can include just a few songs or upwards of thousands of songs.

Block 404 can be a client side process 412 that obtains the set of songs for the consumer for the subscription period. In some instances, blocks 402 and 404 can be performed responsive to completion of an agreement between the server and the customer regarding the terms of the subscription period. An example of such an agreement 112 is evidenced in relation to FIG. 1.

Blocks 406 and 408 can be either or both of server side 410 and client side 412 processes. At block 406, the technique can track the customer's usage of individual songs of the set during the subscription period. In one such example, customer usage is tracked as spins. Songs with higher number of spins during the subscription period can be considered as relatively high use songs compared to songs with a relatively lower number of spins. Relative use can be used to determine which songs the consumer likes and which the songs the consumer dislikes (i.e., consumers tend to repeatedly play songs that the like and not play songs that they don't like).

Block 408 can allow the consumer to keep a sub-set of relatively high use songs and can delete a remainder of the songs of the set. The number of songs included in the sub-set can be established in the agreement between the supplier and the customer.

In summary, the above techniques can offer a consumer enhanced media subscriptions that can offer more value to the consumer than present scenarios. Viewed one way, the consumer pays for a music subscription to get access to a relatively large selection of music for a period of time. In exchange for paying for the subscription, at the end of the period the consumer is given some of the songs from the large selection to keep. The songs that the consumer is allowed to keep are songs that the consumer has shown through his/her actions are the consumer' favorites from the set. Viewed another way, the consumer agrees to buy a number of songs from a set of music. For no additional charge, the consumer is given access to the whole set of music for a period of time.

### Conclusion

Although techniques, methods, devices, systems, etc., pertaining to enhanced media subscription scenarios are described in language specific to structural features and/or methodological acts, it is to be understood that the subject matter defined in the appended claims is not necessarily limited to the specific features or acts described. Rather, the specific features and acts are disclosed as exemplary forms of implementing the claimed methods, devices, systems, etc.

1. A system, comprising:
a media selection module configured to make a set of digital rights restricted songs available to a consumer for a time period;
an activity module configured to track the consumer's use of individual songs of the set of songs during the time period; and,
a digital rights management module configured to remove the digital rights restriction from a sub-set of relatively high use songs at the end of the time period.

2. The system of claim 1, wherein the activity module is configured to track spins of individual songs by the consumer.

3. The system of claim 2, wherein the digital rights management module is further configured to make a remainder of songs of the set that are not in the sub-set inaccessible to the consumer.

4. The system of claim 1, wherein the media selection module, the activity module, and the digital rights management module are resident on a server computing device.

5. The system of claim 1, further comprising a fee calculation module for generating an agreement containing terms associated with the time period such that the agreement can be presented for acceptance by the consumer.

6. The system of claim 5, wherein the fee calculation module is configured to display the agreement on a graphical user interface on a media player device that belongs to the consumer.

7. A computer-readable storage media having instructions stored thereon that when executed by a computing device cause the computing device to perform acts, comprising:
supplying a set of songs to a consumer for a subscription period;
tracking the customer's use of individual songs of the set during the subscription period; and,
allowing the consumer to keep a sub-set of relatively high use songs and deleting a remainder of the songs of the set.

8. The computer-readable storage media of claim 7, wherein the tracking comprises tracking a number of spins for each song of the set.

9. The computer-readable storage media of claim 7, wherein the allowing comprises removing any use-restrictions on the songs of the sub-set.

10. The computer-readable storage media of claim 7, further comprising reaching an agreement with the consumer regarding terms of the subscription period.

11. The computer-readable storage media of claim 10, wherein the terms comprise one or more of: duration of the subscription period, number of subscription periods, cost per subscription period, and a number of songs the consumer is given at the end of each subscription period.

12. The computer-readable storage media of claim 11, wherein the supplying, tracking, and allowing are repeated according to the number of subscription periods specified in the agreement.

13. The computer-readable storage media of claim 11, wherein the allowing comprises providing the consumer full ownership rights in the high use songs of the sub-set.

14. A computer-readable storage media having instructions stored thereon that when executed by a computing device cause the computing device to perform acts, comprising:
providing digital rights restricted media to a consumer for a period; and,
at an end of the period, based at least in part on consumer use, removing the digital rights restrictions from some of the media and deleting other of the media.

15. The computer-readable storage media of claim 14, wherein the providing comprises supplying a set of songs.

16. The computer-readable storage media of claim 14, wherein the providing is performed by a server computing device that supplies the digital rights restricted media to a media player device that belongs to the consumer.

17. The computer-readable storage media of claim 14, wherein the providing is performed by a media player device that obtains the digital rights restricted media for the consumer.

18. The computer-readable storage media of claim 14, wherein the providing and the removing are performed for multiple sequential periods.

19. The computer-readable storage media of claim 14, wherein the providing and the removing are performed for twelve sequential periods with each sequential period having a duration of one month.

20. The computer-readable storage media of claim 14, further comprising charging the consumer a single fee that covers both the providing and the removing.
